(19) United States
(12) Patent Application Publication
(10) Pub. No.: US 2026/0287632 A1
(43) Pub. Date: Sep. 24, 2026

(54) GROUND FAULT IDENTIFICATION WITH IOT ENABLED MONITORS

(71) Applicant: Volta Insite (US) Inc., Cornelius, NC (US)

(72) Inventors: Denis Kouroussis, Markham (CA); Karl Lindstrom, Sunnyvale, CA (US); Daniel Montbriand, Santa Cruz, CA (US); Jaspreet Singh, Brampton (CA); Darcy Tangedal, Athabasca (CA)

(73) Assignee: Volta Insite (US) Inc., Cornelius, NC (US)

(21) Appl. No.: 19/690,329

(22) Filed: May 28, 2026

Related U.S. Application Data
(63) Continuation-in-part of application No. 19/643,944, filed on Apr. 10, 2026.
Application No. 19/643,944 is a continuation-in-part of application No. 19/630,591, filed on Mar. 27, 2026.
Application No. 19/630,591 is a continuation-in-part of application No. 19/565,654, filed on Mar. 13, 2026.
(60) Provisional application No. 63/771,714, filed on Mar. 14, 2025.
(60) Provisional application No. 63/779,393, filed on Mar. 28, 2025.
(60) Provisional application No. 63/787,764, filed on Apr. 12, 2025.
(60) Provisional application No. 63/814,170, filed on May 29, 2025.
(60) Provisional application No. 63/824,111, filed on Jun. 15, 2025.
(60) Provisional application No. 63/842,417, filed on Jul. 11, 2025.
(60) Provisional application No. 63/868,054, filed on Aug. 21, 2025.
(60) Provisional application No. 63/875,633, filed on Sep. 4, 2025.
(60) Provisional application No. 63/886,244, filed on Sep. 23, 2025.
(60) Provisional application No. 63/893,080, filed on Oct. 3, 2025.
(60) Provisional application No. 63/908,902, filed on Oct. 31, 2025.
(60) Provisional application No. 63/920,989, filed on Nov. 19, 2025.
(60) Provisional application No. 63/920,997, filed on Nov. 19, 2025.
(60) Provisional application No. 63/927,701, filed on Nov. 30, 2025.
(60) Provisional application No. 63/933,557, filed on Dec. 8, 2025.
(60) Provisional application No. 63/951,992, filed on Dec. 31, 2025.
(60) Provisional application No. 63/969,898, filed on Jan. 28, 2026.
(60) Provisional application No. 63/980,195, filed on Feb. 11, 2026.
(60) Provisional application No. 63/980,279, filed on Feb. 11, 2026.
(60) Provisional application No. 63/991,428, filed on Feb. 26, 2026.
(60) Provisional application No. 63/991,451, filed on Feb. 26, 2026.
(60) Provisional application No. 63/994,200, filed on Mar. 2, 2026.
(60) Provisional application No. 64/004,156, filed on Mar. 12, 2026.
(60) Provisional application No. 64/019,355, filed on Mar. 27, 2026.
(60) Provisional application No. 64/042,022, filed on Apr. 17, 2026.
(60) Provisional application No. 64/051,859, filed on Apr. 28, 2026.
(60) Provisional application No. 64/054,043, filed on Apr. 30, 2026.
(60) Provisional application No. 64/055,383, filed on May 1, 2026.

(51) Int. Cl. G01R 31/08; H02J 3/0012; H02J 13/12; H02J 13/13

(52) U.S. Cl. CPC G01R 31/086; H02J 3/0012; H02J 13/12; H02J 13/1331

(57) ABSTRACT

A plurality of nodes within an electrical distribution system is monitored by one or more industrial IoT electrical monitors (IIEMs). The plurality of nodes is coupled to a common transformer. A first IIEM within the one or more IIEMs is coupled to one or more nodes within the plurality of nodes. At least one industrial device is coupled to the one or more nodes. The one or more IIEMs are coupled to an aggregation point. The first IIEM decides that a first power quality event (PQE) occurred based on the monitoring. The first PQE is associated with a first node within the one or more nodes. The first IIEM sends the first PQE to the aggregation point. A ground fault event is detected by the aggregation point based on the first PQE that was sent. The detecting includes a location of a ground fault.

### RELATED APPLICATIONS

This application claims the benefit of U.S. provisional patent applications “Ground Fault Identification With IOT Enabled Monitors” Ser. No. 63/814,170, filed May 29, 2025, “Detection And Response To Frequency Deviations With IOT Enabled Monitors” Ser. No. 63/824,111, filed Jun. 15, 2025, “Frequency Deviation Detection And Response With IOT-Enabled Monitors” Ser. No. 63/842,417, filed Jul. 11, 2025, “Industrial Device Root Cause Analysis With Artificial Intelligence Agents” Ser. No. 63/868,054, filed Aug. 21, 2025, “Root Cause Analysis On Industrial Devices With Artificial Intelligence Agents” Ser. No. 63/875,633, filed Sep. 4, 2025, “Contactor Monitoring And Analysis With IOT-Enabled Monitors” Ser. No. 63/886,244, filed Sep. 23, 2025, “Variable Frequency Drive Isolation With IOT-Enabled Monitors” Ser. No. 63/893,080, filed Oct. 3, 2025, “Reconstruction Of Saturated Electrical Data With Industrial IOT Electrical Monitors” Ser. No. 63/908,902, filed Oct. 31, 2025, “Aggregated Analysis Of Electrical Signatures With Event Filters And Industrial IOT-Enabled Monitors” Ser. No. 63/920,989, filed Nov. 19, 2025, “Self-Regulating Industrial IOT-Enabled Monitors (IIEMS) With Event Filters” Ser. No. 63/920,997, filed Nov. 19, 2025, “Monitoring Variable Resolution Electrical Data With Industrial IOT Electrical Monitors” Ser. No. 63/927,701, filed Nov. 30, 2025, “Isolation For Electrical Analysis Of Industrial Equipment With Industrial IOT-Enabled Monitors” Ser. No. 63/933,557, filed Dec. 8, 2025, “Managing Anomalous Events Associated With Industrial Devices With An Applications Engineer Artificial Intelligence Agent” Ser. No. 63/951,992, filed Dec. 31, 2025, “Automatic Initialization Of Industrial IOT-Enabled Monitors” Ser. No. 63/969,898, filed Jan. 28, 2026, “Initializing Industrial IOT-Enabled Monitors With Zero Crossing Time Lags” Ser. No. 63/980,195, filed Feb. 11, 2026, “Residual Back EMF Analysis With Industrial IOT-Enabled Monitors Coupled To Industrial Devices” Ser. No. 63/980,279, filed Feb. 11, 2026, “Recognizing Anomalous Events With Frequency Transformations By IOT-Enabled Monitors” Ser. No. 63/991,428, filed Feb. 26, 2026, “Internal Temperature Tracking Of Industrial Devices With IOT-Enabled Monitors” Ser. No. 63/991,451, filed Feb. 26, 2026, “Auto Channel Mapping For IOT-Enabled Monitors Coupled To Industrial Devices” Ser. No. 63/994,200, filed Mar. 2, 2026, “Root Cause Analysis Of An Anomalous Event With An Applications Engineer Artificial Intelligence Agent” Ser. No. 64/004,156, filed Mar. 12, 2026, “In-Place Testing Of Industrial Equipment With Industrial IOT Enabled Monitors And Electrical Injection” Ser. No. 64/019,355, filed Mar. 27, 2026, “Aggregating Electrical Signal Nodes With IOT Enabled Electrical Monitors” Ser. No. 64/042,022, filed Apr. 17, 2026, “Developing An Anomalous Event Chronology With IOT Enabled Electrical Monitors” Ser. No. 64/055,383, filed May 1, 2026, “Predicting Fuse Failure With IOT Enabled Electrical Monitors” Ser. No. 64/054,043, filed Apr. 30, 2026, and “Detecting Anomalous Events By Work Cycle Waveform Shape” Ser. No. 64/051,859, filed Apr. 28, 2026.

This application is also a continuation-in-part of U.S. patent application “Identification Of Electrical Signatures With Local Machine Learning Models On An IOT-Enabled Monitor” Ser. No. 19/643,944, filed Apr. 10, 2026, which claims the benefit of U.S. provisional patent applications “Identification Of Electrical Signatures With Local Machine Learning Models On An IOT-Enabled Monitor” Ser. No. 63/787,764, filed Apr. 12, 2025, “Ground Fault Identification With IOT Enabled Monitors” Ser. No. 63/814,170, filed May 29, 2025, “Detection And Response To Frequency Deviations With IOT Enabled Monitors” Ser. No. 63/824,111, filed Jun. 15, 2025, “Frequency Deviation Detection And Response With IOT-Enabled Monitors” Ser. No. 63/842,417, filed Jul. 11, 2025, “Industrial Device Root Cause Analysis With Artificial Intelligence Agents” Ser. No. 63/868,054, filed Aug. 21, 2025, “Root Cause Analysis On Industrial Devices With Artificial Intelligence Agents” Ser. No. 63/875,633, filed Sep. 4, 2025, “Contactor Monitoring And Analysis With IOT-Enabled Monitors” Ser. No. 63/886,244, filed Sep. 23, 2025, “Variable Frequency Drive Isolation With IOT-Enabled Monitors” Ser. No. 63/893,080, filed Oct. 3, 2025, “Reconstruction Of Saturated Electrical Data With Industrial IOT Electrical Monitors” Ser. No. 63/908,902, filed Oct. 31, 2025, “Aggregated Analysis Of Electrical Signatures With Event Filters And Industrial IOT-Enabled Monitors” Ser. No. 63/920,989, filed Nov. 19, 2025, “Self-Regulating Industrial IOT-Enabled Monitors (IIEMS) With Event Filters” Ser. No. 63/920,997, filed Nov. 19, 2025, “Monitoring Variable Resolution Electrical Data With Industrial IOT Electrical Monitors” Ser. No. 63/927,701, filed Nov. 30, 2025, “Isolation For Electrical Analysis Of Industrial Equipment With Industrial IOT-Enabled Monitors” Ser. No. 63/933,557, filed Dec. 8, 2025, “Managing Anomalous Events Associated With Industrial Devices With An Applications Engineer Artificial Intelligence Agent” Ser. No. 63/951,992, filed Dec. 31, 2025, “Automatic Initialization Of Industrial IOT-Enabled Monitors” Ser. No. 63/969,898, filed Jan. 28, 2026, “Initializing Industrial IOT-Enabled Monitors With Zero Crossing Time Lags” Ser. No. 63/980,195, filed Feb. 11, 2026, “Residual Back EMF Analysis With Industrial IOT-Enabled Monitors Coupled To Industrial Devices” Ser. No. 63/980,279, filed Feb. 11, 2026, “Recognizing Anomalous Events With Frequency Transformations By IOT-Enabled Monitors” Ser. No. 63/991,428, filed Feb. 26, 2026, “Internal Temperature Tracking Of Industrial Devices With IOT-Enabled Monitors” Ser. No. 63/991,451, filed Feb. 26, 2026, “Auto Channel Mapping For IOT-Enabled Monitors Coupled To Industrial Devices” Ser. No. 63/994,200, filed Mar. 2, 2026, “Root Cause Analysis Of An Anomalous Event With An Applications Engineer Artificial Intelligence Agent” Ser. No. 64/004,156, filed Mar. 12, 2026, and “In-Place Testing Of Industrial Equipment With Industrial IOT Enabled Monitors And Electrical Injection” Ser. No. 64/019,355, filed Mar. 27, 2026.

The U.S. patent application “Identification Of Electrical Signatures With Local Machine Learning Models On An IOT-Enabled Monitor” Ser. No. 19/643,944, filed Apr. 10, 2026 is also a continuation-in-part of U.S. patent application “Autonomous Identification Of Electrical Signatures With IOT-Enabled Monitors” Ser. No. 19/630,591, filed Mar. 27, 2026, which claims the benefit of U.S. provisional patent applications “Autonomous Identification Of Electrical Signatures With IOT-Enabled Monitors” Ser. No. 63/779,393, filed Mar. 28, 2025, “Identification Of Electrical Signatures With Local Machine Learning Models On An IOT-Enabled Monitor” Ser. No. 63/787,764, filed Apr. 12, 2025, “Ground Fault Identification With IOT Enabled Monitors” Ser. No. 63/814,170, filed May 29, 2025, “Detection And Response To Frequency Deviations With IOT Enabled Monitors” Ser. No. 63/824,111, filed Jun. 15, 2025, “Frequency Deviation Detection And Response With IOT-Enabled Monitors” Ser. No. 63/842,417, filed Jul. 11, 2025, “Industrial Device Root Cause Analysis With Artificial Intelligence Agents” Ser. No. 63/868,054, filed Aug. 21, 2025, “Root Cause Analysis On Industrial Devices With Artificial Intelligence Agents” Ser. No. 63/875,633, filed Sep. 4, 2025, “Contactor Monitoring And Analysis With IOT-Enabled Monitors” Ser. No. 63/886,244, filed Sep. 23, 2025, “Variable Frequency Drive Isolation With IOT-Enabled Monitors” Ser. No. 63/893,080, filed Oct. 3, 2025, “Reconstruction Of Saturated Electrical Data With Industrial IOT Electrical Monitors” Ser. No. 63/908,902, filed Oct. 31, 2025, “Aggregated Analysis Of Electrical Signatures With Event Filters And Industrial IOT-Enabled Monitors” Ser. No. 63/920,989, filed Nov. 19, 2025, “Self-Regulating Industrial IOT-Enabled Monitors (IIEMS) With Event Filters” Ser. No. 63/920,997, filed Nov. 19, 2025, “Monitoring Variable Resolution Electrical Data With Industrial IOT Electrical Monitors” Ser. No. 63/927,701, filed Nov. 30, 2025, “Isolation For Electrical Analysis Of Industrial Equipment With Industrial IOT-Enabled Monitors” Ser. No. 63/933,557, filed Dec. 8, 2025, “Managing Anomalous Events Associated With Industrial Devices With An Applications Engineer Artificial Intelligence Agent” Ser. No. 63/951,992, filed Dec. 31, 2025, “Automatic Initialization Of Industrial IOT-Enabled Monitors” Ser. No. 63/969,898, filed Jan. 28, 2026, “Initializing Industrial IOT-Enabled Monitors With Zero Crossing Time Lags” Ser. No. 63/980,195, filed Feb. 11, 2026, “Residual Back EMF Analysis With Industrial IOT-Enabled Monitors Coupled To Industrial Devices” Ser. No. 63/980,279, filed Feb. 11, 2026, “Recognizing Anomalous Events With Frequency Transformations By IOT-Enabled Monitors” Ser. No. 63/991,428, filed Feb. 26, 2026, “Internal Temperature Tracking Of Industrial Devices With IOT-Enabled Monitors” Ser. No. 63/991,451, filed Feb. 26, 2026, “Auto Channel Mapping For IOT-Enabled Monitors Coupled To Industrial Devices” Ser. No. 63/994,200, filed Mar. 2, 2026, and “Root Cause Analysis Of An Anomalous Event With An Applications Engineer Artificial Intelligence Agent” Ser. No. 64/004,156, filed Mar. 12, 2026.

The U.S. patent application “Autonomous Identification Of Electrical Signatures With IOT-Enabled Monitors” Ser. No. 19/630,591, filed Mar. 27, 2026 is also a continuation-in-part of “Continuous Capture Of Electrical Signatures With IOT Enabled Monitors” Ser. No. 19/565,654, filed Mar. 13, 2026, which claims the benefit of U.S. provisional patent applications “Continuous Capture Of Electrical Signatures With IOT Enabled Monitors” Ser. No. 63/771,714, filed Mar. 14, 2025, “Autonomous Identification Of Electrical Signatures With IOT-Enabled Monitors” Ser. No. 63/779,393, filed Mar. 28, 2025, “Identification Of Electrical Signatures With Local Machine Learning Models On An IOT-Enabled Monitor” Ser. No. 63/787,764, filed Apr. 12, 2025, “Ground Fault Identification With IOT Enabled Monitors” Ser. No. 63/814,170, filed May 29, 2025, “Detection And Response To Frequency Deviations With IOT Enabled Monitors” Ser. No. 63/824,111, filed Jun. 15, 2025, “Frequency Deviation Detection And Response With IOT-Enabled Monitors” Ser. No. 63/842,417, filed Jul. 11, 2025, “Industrial Device Root Cause Analysis With Artificial Intelligence Agents” Ser. No. 63/868,054, filed Aug. 21, 2025, “Root Cause Analysis On Industrial Devices With Artificial Intelligence Agents” Ser. No. 63/875,633, filed Sep. 4, 2025, “Contactor Monitoring And Analysis With IOT-Enabled Monitors” Ser. No. 63/886,244, filed Sep. 23, 2025, “Variable Frequency Drive Isolation With IOT-Enabled Monitors” Ser. No. 63/893,080, filed Oct. 3, 2025, “Reconstruction Of Saturated Electrical Data With Industrial IOT Electrical Monitors” Ser. No. 63/908,902, filed Oct. 31, 2025, “Aggregated Analysis Of Electrical Signatures With Event Filters And Industrial IOT-Enabled Monitors” Ser. No. 63/920,989, filed Nov. 19, 2025, “Self-Regulating Industrial IOT-Enabled Monitors (IIEMS) With Event Filters” Ser. No. 63/920,997, filed Nov. 19, 2025, “Monitoring Variable Resolution Electrical Data With Industrial IOT Electrical Monitors” Ser. No. 63/927,701, filed Nov. 30, 2025, “Isolation For Electrical Analysis Of Industrial Equipment With Industrial IOT-Enabled Monitors” Ser. No. 63/933,557, filed Dec. 8, 2025, “Managing Anomalous Events Associated With Industrial Devices With An Applications Engineer Artificial Intelligence Agent” Ser. No. 63/951,992, filed Dec. 31, 2025, “Automatic Initialization Of Industrial IOT-Enabled Monitors” Ser. No. 63/969,898, filed Jan. 28, 2026, “Initializing Industrial IOT-Enabled Monitors With Zero Crossing Time Lags” Ser. No. 63/980,195, filed Feb. 11, 2026, “Residual Back EMF Analysis With Industrial IOT-Enabled Monitors Coupled To Industrial Devices” Ser. No. 63/980,279, filed Feb. 11, 2026, “Recognizing Anomalous Events With Frequency Transformations By IOT-Enabled Monitors” Ser. No. 63/991,428, filed Feb. 26, 2026, “Internal Temperature Tracking Of Industrial Devices With IOT-Enabled Monitors” Ser. No. 63/991,451, filed Feb. 26, 2026, and “Auto Channel Mapping For IOT-Enabled Monitors Coupled To Industrial Devices” Ser. No. 63/994,200, filed Mar. 2, 2026.

Each of the foregoing applications is hereby incorporated by reference in its entirety.

### FIELD OF ART

This application relates generally to analysis, and more particularly to ground fault identification with IoT-enabled monitors.

### BACKGROUND

Industrial equipment such as conveyor systems, CNC (computer numerical control) machines, and other motorized machinery plays a vital role in maintaining infrastructure and supporting the broader economy. These systems streamline manufacturing, logistics, and construction processes by enabling high-volume, high-precision, continuous operation that would be impossible through manual labor alone. Conveyor systems keep supply chains moving efficiently, while CNC machines ensure consistent, accurate production of parts essential to infrastructure (such as bridges and vehicles), energy grids, water systems, and so on. Together, this machinery reduces production costs, increases throughput, and supports economic growth by enhancing productivity across multiple sectors.

Industrial equipment forms the backbone of modern manufacturing and logistics operations by enhancing speed, accuracy, and overall productivity. In logistics hubs, technologies such as automated conveyors, vertical storage systems, and robotic sorting units facilitate efficient inventory handling, leading to quicker and more reliable shipping and receiving. In manufacturing environments, sophisticated equipment such as robotic arms, mixers, extruders, and laser cutting tools enable precise fabrication and packaging of products. Robotic systems are especially effective for repetitive tasks like assembly, welding, and moving materials, helping to increase throughput while minimizing reliance on manual labor. Proper air handling is maintained through powerful ventilation systems that regulate temperature and remove pollutants such as dust, vapors, or heat buildup. Specialized equipment like ovens, kilns, and curing chambers support a wide range of industrial processes, from food production to ceramics, metallurgy, and pharmaceutical applications. CNC machines provide the ability to accurately machine complex shapes across different materials, allowing for consistent, high-quality output. Meanwhile, separators and centrifuges are critical in sectors like chemical processing and wastewater management for their role in effectively isolating solids from liquids. Automated packaging systems, including form-fill-seal units, capping machines, and shrink wrappers, significantly boost operational efficiency, uphold sanitary standards, and deliver uniform packaging, making them vital to the food, beverage, and consumer goods industries.

In addition, data centers play a critical role in the foundation of modern infrastructure by powering industry operations, fostering technological advancements, and enabling international commerce. Key sectors such as manufacturing, logistics, retail, and finance rely heavily on the computing capabilities of data centers to maintain continuous operations and accommodate growth. Businesses depend on these facilities to support cloud computing, artificial intelligence workloads, and big data analytics, including tools that enhance operational efficiency and inform strategic decisions. Services such as online retail, banking, and streaming media require rapid, secure data handling to provide users with real-time functionality. Likewise, essential public institutions, including hospitals, emergency services, and government bodies, depend on data centers for the secure storage and constant availability of critical data. Behind the scenes, a combination of servers, networking gear, power distribution units, and precision cooling systems ensure high availability, consistent performance, and robust data protection. These systems allow mission-critical services to function largely without interruption.

Industrial equipment is essential to the functioning of the global economy, enabling companies to manufacture goods and deliver services with greater speed, safety, and precision. Industrial equipment empowers organizations to expand production capacity, reduce operational costs, and maintain uniform quality across outputs. The infrastructure of modern life is deeply dependent on the continuous and reliable operation of such equipment. Without it, the efficiency and scale of today's industries, and the conveniences they provide, would be fundamentally disrupted.

### SUMMARY

Failures in industrial equipment can lead to significant disruptions across both production processes and broader supply chains. When a critical system breaks down, manufacturing lines may grind to a halt, jeopardizing output, delivery timelines, and customer commitments. Such breakdowns often result in wasted materials, particularly in sectors like food processing or chemical production, where ingredients may spoil or degrade beyond usability. These disruptions can cascade through supply chains, triggering shortages of key goods and hindering the operations of downstream businesses that depend on timely deliveries. Beyond financial losses and reputational damage, equipment failures can also introduce serious safety risks. Malfunctioning machinery can pose immediate hazards to on-site personnel through mechanical breakdowns, overheating, chemical exposure, etc. Moreover, defective industrial systems such as power generators, high-capacity pumps, or automated controls can endanger people away from the equipment itself. For example, a faulty generator supplying electricity to a distant region may cause unstable power delivery or outages that compromise critical infrastructure and endanger public safety.

Disclosed embodiments provide enhanced techniques for equipment monitoring. Multiple nodes within an electrical distribution system are monitored by one or more industrial IoT electrical monitors (IIEMs). The multiple nodes are coupled to a common transformer, and at least one industrial device is coupled to the one or more nodes. The one or more IIEMs are coupled to an aggregation point. An IIEM from the one or more IIEMs can decide that a power quality event (PQE) occurred, where the PQE is associated with a node within the one or more nodes, where the deciding is based on the monitoring. The IIEM sends the PQE to the aggregation point. The aggregation point analyzes the PQE to detect a ground fault event, where the detecting includes a location of a ground fault.

A computer-implemented method for analysis is disclosed comprising: monitoring, by one or more industrial IoT electrical monitors (IIEMs), a plurality of nodes within an electrical distribution system, wherein the plurality of nodes is coupled to a common transformer, wherein a first IIEM within the one or more IIEMs is coupled to one or more nodes within the plurality of nodes, wherein at least one industrial device is coupled to the one or more nodes, and wherein the one or more IIEMs are coupled to an aggregation point; deciding, by the first IIEM, that a first power quality event (PQE) occurred, wherein the first PQE is associated with a first node within the one or more nodes, and wherein the deciding is based on the monitoring; sending, by the first IIEM, the first PQE to the aggregation point; and detecting a ground fault event, by the aggregation point, wherein the detecting is based on the first PQE that was sent, and wherein the detecting includes a location of a ground fault. In embodiments, the first PQE includes a rise, within the first node, in a voltage phase above a voltage rise threshold, wherein the voltage rise threshold is twice a normal operating voltage rise rate. In embodiments, the first PQE includes a rise, within the first node, in a current phase above a current rise threshold, wherein the current rise threshold is twice a normal operating current rise rate. In embodiments, the first PQE includes a phase difference, within the first node, between a voltage phase of power and a current phase of power, wherein the phase difference is above a phase threshold. Embodiments can include monitoring, by the first IIEM, the phase difference. In embodiments, the first PQE includes a rate of change of the phase difference above a phase difference threshold rate.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for ground fault identification with IoT-enabled monitors.

FIG. 2 is a flow diagram for detecting a second event.

FIG. 3 is an infographic for IoT environments.

FIG. 4 is an example of monitoring an electrical distribution system.

FIG. 5 is an example of three-phase power.

FIG. 6 is an example of a rapid rise or fall in current or voltage at a rate above a threshold.

FIG. 7 is an example of a rise in current or voltage above a threshold.

FIG. 8 is an example of a phase difference between voltage and current.

FIG. 9 is a system diagram for ground fault identification with IoT-enabled monitors.

### DETAILED DESCRIPTION

Ground faults in an industrial environment can pose serious hazards, both to equipment and to human safety. When electrical current unintentionally flows to ground, rather than following its intended path, the electrical current can result in excessive heat, arcing, or electrical shock conditions. Ground faults can be particularly dangerous in facilities that rely on heavy-duty equipment such as motors, pumps, compressors, HVAC systems, industrial fans, etc. For example, a ground fault in a motor-driven conveyor system might cause overheating, leading to insulation breakdown or even fire. Similarly, if a compressor or pump develops a ground fault, the equipment may continue running with unbalanced electrical loads, which can accelerate wear, trigger catastrophic failure, or cause unanticipated shutdowns in production lines.

Beyond equipment damage, ground faults can create unsafe working conditions for personnel. Exposed conductive surfaces may become energized, posing electrocution risks to workers performing routine maintenance or operations. Ground faults can also disable protective devices like circuit breakers or fuses if the fault current is too low to trip them, allowing hazardous conditions to persist unnoticed. In HVAC systems and/or ventilation fans, undetected faults may impair airflow or environmental controls, affecting air quality or increasing the risk of overheating in sensitive areas. Furthermore, ground faults can disrupt control systems and/or create cascading electrical failures that extend beyond the original fault location, amplifying the potential for injuries, property damage, and operational downtime. Early detection and prompt response to ground faults are essential to protecting both personnel and infrastructure.

Typical methods of identifying ground faults can use a neutral ground resistor (NGR) within a transformer such as a delta or wye transformer. A voltage drop can be sensed by a relay which can signal that the system has detected a ground fault. However, this method can result in excessive voltage spikes when the ground fault occurs. Alternatively, current through the NGR can be monitored and a relay can pick up when current reaches a preset level. Once a fault is detected, additional means can be required for locating the ground fault (e.g., locating the specific machine in which the ground fault exists). Finding the ground fault can also include additional equipment and procedures, such as a second NGR, current imbalance monitoring equipment, and/or manual inspection. This can require shutting down equipment resulting in a loss of productivity.

Disclosed implementations utilize an Industrial Internet of Things (IoT) Electrical Monitor (IIEM) to enable a smart, adaptive approach to monitoring industrial equipment, improving uptime, efficiency, reliability, and cost. Internet of Things (IoT) refers to a network of interconnected devices embedded with sensors, software, and/or communication technologies that collect and exchange data over the Internet or other suitable network. The IIEM can enable continuous capture of electrical signatures with IoT-enabled monitors and can upload electrical data to an aggregation point for analysis. The aggregation point can be a device located on premises at the industrial facility, or in a cloud server. The IIEM can provide real-time alerts for potential failures such as ground faults, unusual power consumption, operational inefficiencies, and so on, enabling intelligent real-time monitoring, automation, and data-driven decision making across various industries. In industrial settings, disclosed implementations can play a crucial role in optimizing operations, improving efficiency, and reducing downtime by providing improved access to, and analysis of, industrial device performance data. One or more IIEMs can monitor power supply conditions to detect a ground fault by monitoring input electrical parameters such as voltage and current, capturing peak levels of voltage and/or current, collecting rise time measurements (the rate at which voltage or current increases), monitoring phase relationship between voltage and current, and so on. IIEM monitors such as described herein enable ground fault detection.

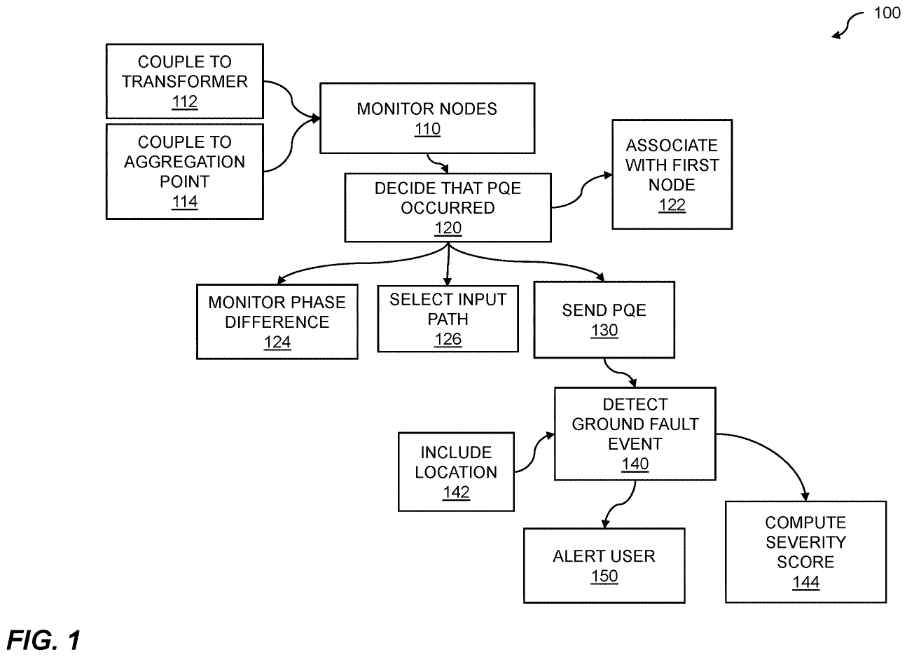

FIG. 1 is a flow diagram for ground fault identification with IoT-enabled monitors. The flow 100 can include monitoring, by one or more industrial IoT electrical monitors (IIEMs), a plurality of nodes 110 within an electrical distribution system. The IIEMs can include one or more processors, storage, communications, one or more power supplies such as a battery, and so on. The IIEM can include a single board computer (SBC) such as a Raspberry Pi® device, Banana Pi® device, BeagleBone® device, NVIDIA Jetson Nano®, a custom-designed computing device, etc. The IIEM can include sensors to measure operational data associated with one or more industrial devices. The operational data can include voltage, current, vibration, humidity, airflow, temperature, and the like. The IIEM can perform local processing on the operational data such as a Fast Fourier transform (FFT), Short-Time Fourier Transform (STFT), statistical analysis, data filtering, detection of voltage and/or current spikes, root mean square (RMS) calculations, zero-crossing rate, and/or other relevant calculations. The nodes can represent an electrical input to the IIEM from a piece of industrial equipment, such as an electrical output from a piece of industrial equipment or a point within the electrical path within a piece of industrial equipment. The equipment can be coupled to an electrical distribution system within an industrial environment such as a manufacturing center, a data center, and so on. The monitoring can include monitoring current, monitoring voltage, monitoring phase, monitoring temperature of conductors, and/or other parameters associated with electrical power. One or more IIEMs can monitor any number of nodes associated with any number of industrial devices. In embodiments, the monitoring is based on a sampling frequency. Electrical data from nodes monitored by each IIEM can be collected based on a sampling frequency. In some embodiments, the sampling frequency is 20 kHz. Any suitable sampling frequency can be used. Recall that each IIEM can monitor any number of nodes within an electrical distribution system. Each node can be sampled at a different sampling frequency. The collection can be based on other factors, such as frequency of failure, severity of failure, criticality of the node, etc. For example, if a node has proven to be problematic in the past, the IIEM may increase the sampling frequency on that node while keeping the sampling rate lower for other nodes. Sampling rates can be programmed by a user and changed at any time. The sampling can be based on an event. For example, if an event such as a power quality event (PQE) is detected on one node, the IIEM can increase the sampling frequency on other nodes. In addition, other IIEMs in the system can be notified of the event and can also decide to change their sampling rates.

In the flow 100, the plurality of nodes is coupled to a common transformer 112. Electrical transformers can play an important role in managing power distribution by stepping voltages up or down to meet the specific requirements of various types of equipment. Industrial facilities may operate on three-phase power due to its efficiency in delivering large amounts of energy to heavy machinery such as motors, compressors, HVAC systems, and production equipment. The transformer that is coupled can include a dry-type transformer, oil-filled transformer, isolation transformer, autotransformer, and/or other suitable type of transformer. Additionally, the transformer that is coupled can include a three-phase transformer. The three-phase transformer can be configured in a delta-wye configuration, a wye-wye configuration, etc., depending on the facility's grounding and load requirements.

The flow 100 can include coupling to an aggregation point 114. An aggregation point can serve as a centralized computing resource for collecting, analyzing, and interpreting electrical measurement data collected by one or more IIEMs from transformers and other industrial equipment within a facility. The aggregation point can include processors, memory, machine learning accelerators, I/O devices, support communications such as Ethernet, Bluetooth®, cellular communications such as 5G, wireless communications, etc. The aggregation point can coordinate and perform analysis on data sent by the IIEMs within the environment such as comparing to thresholds, performing transformations such as Fast Fourier Transformations (FFTs), statistical analysis, data filtering, evaluating synchronous events, determining the existence of a ground fault, and so on. A major benefit of an aggregation point is enabling rapid identification and localization of electrical anomalies, particularly ground faults, which can disrupt operations and pose safety risks. By aggregating data from multiple Industrial IoT Electrical Monitors (IIEMs) spread throughout the facility, the aggregation point can correlate measurements such as current and voltage rise times, phase shifts, and peak amplitudes across equipment nodes. This holistic view allows disclosed implementations to not only detect the presence of a ground fault, but also isolate its likely origin, for instance, pinpointing the specific transformer or motor group affected. Implementation of the aggregation point can vary based on infrastructure and latency requirements. In cloud-centric deployments, the aggregation point may be hosted on bare-metal servers, virtual machines (VMs), or containerized applications orchestrated via platforms like Kubernetes®. These setups benefit from scalability, centralized data access, and powerful long-term analytics using machine learning models. However, for environments where internet connectivity is limited or where real-time response is critical, an on-premises aggregation point, such as a multicore industrial workstation, offers significant advantages. An on-premises aggregation point can provide low-latency decision-making, triggering alerts or shutdowns instantly to protect equipment and personnel. In some examples, one or more aggregation points can be utilized. This can be helpful for a large deployment of IIEM monitors across a large facility. The one or more aggregation points can be hierarchically arranged and can coordinate data from one or more coupled IIEMs.

Disclosed implementations can include a hybrid model that can further enhance flexibility and reliability. In this approach, an on-premises aggregation point can handle immediate fault detection and protective actions, while concurrently transmitting data to a cloud-based aggregation point for deeper, long-term analysis, such as trend detection, predictive maintenance insights, or benchmarking across facilities. This layered strategy can provide both real-time responsiveness and advanced intelligence, adapting to the diverse operational needs of modern industrial environments. Embodiments include monitoring, by one or more industrial IoT electrical monitors (IIEMs), a plurality of nodes within an electrical distribution system, wherein the plurality of nodes is coupled to a common transformer, wherein a first IIEM within the one or more IIEMs is coupled to one or more nodes within the plurality of nodes, wherein at least on industrial device is coupled to the one or more nodes, and wherein the one or more IIEMs are coupled to an aggregation point. In embodiments, the aggregation point comprises an edge compute device. In embodiments, the aggregation point comprises a cloud server.

The flow 100 includes deciding that a power quality event (PQE) occurred 120. Embodiments include deciding, by the first IIEM, that a first power quality event (PQE) occurred, wherein the first PQE is associated with a first node within the one or more nodes, and wherein the deciding is based on the monitoring. An IIEM can be configured to identify power quality events (PQEs) by analyzing incoming electrical measurements, such as voltage and current, from nodes which are monitored. The analyzing can be continuous. The IIEM can detect a PQE when measured electrical characteristics exceed defined thresholds or deviate from expected temporal and/or phase patterns. The flow 100 includes associating a PQE with a first node 122. As described earlier, an IIEM can be coupled to a plurality of nodes within an electrical distribution system. The IIEM can associate detected power quality events (PQEs) with specific electrical nodes within an industrial facility. These nodes can represent key locations in the power distribution network, such as the output terminals of transformers, switchgear panels, busbars, etc. By linking PQEs to a specific node, the IIEM enables precise localization of anomalies, allowing maintenance personnel to focus their diagnostic efforts on a particular segment of the facility. This targeted approach can significantly reduce downtime and improve the efficiency of ground fault detection, equipment servicing, and predictive maintenance operations.

Many types of PQEs can be identified and captured by the IIEM. Industrial equipment can include typical current and voltage draws during start-up, operation, shutdown, while not in operation, and so on. These draws can occur on any phase of power delivered to the equipment. Thresholds that can indicate a power event at each node can be established. In some embodiments, the first PQE includes a voltage phase, within the first node, above an on-voltage threshold. In some embodiments, the first PQE includes a voltage phase, within the first node, above an off-voltage threshold, wherein the at least one industrial device coupled to the first node is not in operation. In other embodiments, the first PQE includes a current phase above an on-current threshold. In other embodiments, the first PQE includes a current phase, within the first node, above an off-current threshold, wherein the at least one industrial device coupled to the first node is not in operation.

Beyond static thresholds, the IIEM can also detect PQEs by monitoring dynamic behaviors, such as rise time (rate of change) in voltage and current. Typical operating rates can be established and compared to measurements collected by the IIEM during start-up, operation, downtime, etc. A sudden and abnormally fast current ramp-up, for instance, might signal an insulation failure or a short circuit. In embodiments, the first PQE includes a rise, within the first node, in a voltage phase above a voltage rise threshold, wherein the voltage rise threshold is twice a normal operating voltage rise rate. The voltage rise threshold can comprise any multiple of a normal operating voltage rise. In some embodiments, the first PQE includes a rise, within the first node, in a current phase above a current rise threshold, wherein the current rise threshold is twice a normal operating current rise rate. The current rise threshold can comprise any multiple of a normal operating current rise.

The IIEM can also assess the balance and symmetry of three-phase power, detecting PQEs caused by phase loss, phase reversal, phase imbalance, etc. which can degrade equipment performance, cause premature failure, and indicate error conditions such as ground faults. Differences in phase can be measured against a threshold to indicate potential problems. In embodiments, the first PQE includes a phase difference, within the first node, between a voltage phase of power and a current phase of power, wherein the phase difference is above a phase threshold. Additionally, the IIEM can analyze the phase angle between voltage and current on each leg of a three-phase system. A significant and unexpected phase shift can be indicative of a developing ground fault, capacitive leakage, or another fault condition. Embodiments include monitoring, by the first IIEM, the phase difference 124. Monitoring electrical phase data can play a critical role in assessing the overall health and stability of power distribution systems, particularly in industrial environments where three-phase power is widely used. Accurate phase alignment ensures balanced loads, efficient energy use, and proper operation of sensitive equipment. Deviations of voltage and current phase relationships from expected norms can indicate underlying problems that affect both equipment performance and safety. The deviations can change at various rates. These rates can be measured against maximum allowed phase difference threshold rates. For example, a changing phase shift between voltage and current may signal the presence of a ground fault, capacitive leakage, or insulation degradation. If a rate of change of the phase difference between current and voltage changes more quickly than expected, a PQE can be flagged by the IIEM. In embodiments, the first PQEs include a rate of change of the phase difference above a phase difference threshold rate.

The flow 100 can further include selecting an input path 126. Any IIEM within the environment can include more than one input path which can be helpful to avoid false alarms from inrush current, start-up current, etc. In embodiments, the first IIEM includes two input paths, wherein the two input paths comprise different voltage dividers, and wherein the first IIEM includes a programmable real-time unit (PRU). Embodiments can further include selecting, by the PRU, an input path within the two input paths, wherein the selecting is based on a magnitude of an input. Disclosed implementations can include a programmable real-time unit (PRU) within the IIEM that can be used to intelligently manage multiple signal paths for voltage and current sensing, helping to improve measurement fidelity and reduce false positives during equipment startup. One implementation can include two distinct voltage divider circuits. A first circuit is optimized for high-amplitude events like inrush currents during equipment startup (“path A”), and a second circuit is designed for high-resolution monitoring during steady-state operation (“path B”). The PRU can dynamically select between these circuits using relay-controlled or solid-state switching based on real-time input measurements. Other switching methods can be used. For example, during an initial surge in current or voltage, the PRU can detect that the input magnitude exceeds a predefined startup threshold and activate path A, which attenuates the signal more aggressively to prevent ADC saturation and protect sensitive circuitry. After a programmable delay, such as a delay ranging between 500 milliseconds to 2 seconds, the PRU can switch to path B, enabling more precise monitoring of the system's steady-state behavior. The delay can be scaled up or down on a sample-by-sample basis.

The dynamic switching of the PRU can prevent saturation of the analog front end during high inrush events, as well as ensure that low-amplitude steady-state signals are not masked by excessive attenuation. The approach of disclosed implementations can enhance diagnostic resolution and enable more accurate classification of power quality events (PQEs). The PRU can incorporate software or hardware comparators to trigger the switching mechanism and employ hysteresis or filtering logic to avoid rapid toggling or relay chatter. Disclosed implementations can include opto-isolators or isolation amplifiers, which can electrically separate the high-voltage signal domain from low-voltage processing circuits. Additionally, disclosed implementations can log typical startup signatures of connected machinery (e.g., motors, compressors) and compare real-time events against those profiles, flagging any deviations as potential anomalies. This combination of adaptive signal handling, safety isolation, and context-aware analysis provides a robust foundation for accurate and reliable monitoring in electrically noisy industrial environments.

The flow 100 includes sending a PQE 130. Embodiments include sending, by the first IIEM, the first PQE to the aggregation point. As described above and throughout, any number of IIEMs can each monitor one or more nodes of an electrical distribution system within an industrial environment. Each IIEM can log data, run calculations, determine whether a power quality event (PQE) occurred on any monitored node, etc. Each IIEM can send data to an aggregation point. In embodiments, the sending is based on a schedule such as every minute, every ten minutes, daily, weekly, etc. The schedule can be updated by the aggregation point or as events, such as a PQE, are detected. The IIEMs can structure the data before sending it to the aggregation point. For example, the IIEMs can use formats such as JSON, YAML, or XML. Once the data is structured, the IIEM can apply fast compression algorithms, such as gzip and/or zstd, to reduce bandwidth consumption. The compression options can be well suited for facilities with limited or intermittent connectivity. The data payload can then be transmitted to the aggregation point by wire, Ethernet, Bluetooth®, wireless communication protocols, and so on. The aggregation point can be located outside of the environment. The aggregation point can comprise a server, cloud server, etc. When the aggregation point resides outside of the environment, the transmission can include RESTful API calls over HTTPS, ensuring secure and standardized communication. Each payload can include metadata such as timestamps, node identifiers, PQE types, equipment IDs, and a checksum or hash (e.g., MD5 or SHA-256) to verify data integrity. On the aggregation point side, the hash can be recalculated upon receipt and compared to the transmitted value. If the checksum fails, the aggregation point can discard the corrupted packet and optionally send a retransmission request to the originating IIEM. In some implementations, a lightweight message queue protocol such as MQTT with quality of service (QoS) levels can be used instead of raw RESTful HTTP, providing built-in message acknowledgement, ordering, and retransmission features, which can be especially useful in unreliable or high-latency environments. To further enhance reliability and traceability, the IIEM can maintain a local cache or ring buffer of recent PQE data, which enables retransmission if an acknowledgment is not received. The retransmission feature can be particularly valuable in setups where the aggregation point may reside in the cloud and network interruptions are possible. By combining structured data serialization, compression, integrity checks, and reliable transmission protocols, the IIEM can efficiently and accurately deliver critical PQE data to the aggregation point, enabling timely and dependable fault detection across the facility.

The sending can include the use of one or more data structures, such as a relational table, in-memory map, and so on that can catalogue known nodes within the facility. Each node in the table can be uniquely identified by a Node ID and linked with metadata fields including physical coordinates (e.g., floor, room, panel number, etc.), the type of transformer (e.g., dry-type, oil-cooled, autotransformer), the rated capacity of the transformer, and a list of downstream equipment it powers (e.g., motors, compressors, lighting circuits). Additional metadata can include operating voltage level, maintenance history, grounding configuration, and connection topology (e.g., delta or wye). When a PQE is detected, the aggregation point can match the event's origin, based on sensor identifiers and/or signal path tracing, to a node entry in the map. This can allow disclosed implementations to flag the PQE, as well as contextualize a given PQE within the broader infrastructure, making it easier to determine whether the anomaly may be related to specific machinery, loading conditions, or known environmental stressors near that node. In embodiments, the deciding is based on the monitoring.

The flow 100 includes detecting a ground fault event 140. Embodiments include detecting a ground fault event, by the aggregation point, wherein the detecting is based on the first PQE that was sent, wherein the detecting includes a location of the ground fault. In disclosed implementations, IIEM devices deployed throughout the facility can each monitor for PQEs using disclosed techniques. The PQEs can indicate the presence of a ground fault at any node within the environment. One or more IIEMs may send one or more PQEs to the aggregation point, which can indicate a ground fault or more than one ground fault. The detecting can include a location of the ground fault 142. When a PQE is recorded on a single node, the location can be the node. However, the aggregation point can coordinate, compare, analyze, etc. the data from many IIEMs to determine a node on which the ground fault occurred. When multiple IIEMs send PQEs, the aggregation point can determine whether the PQEs are synchronous events (e.g., attributable to the same fault), or disparate events. Thus, the aggregation point can determine faults occurring at one or more locations throughout the environment.

The location of a ground fault event (GFE) can be specified using a structured hierarchy of spatial descriptors that enable precise and unambiguous localization within a facility. In a usage example, each GFE record may include a building identifier, floor identifier, and sector or zone identifier, allowing maintenance personnel to quickly pinpoint the affected area, even in large or multi-structure facilities. Additional location metadata could include room number, grid coordinates, and/or rack or panel identifiers (e.g., electrical panel ID or equipment enclosure ID), depending on the granularity of the monitoring system. Associating each IIEM and node with such spatial metadata, either through manual configuration or auto-discovery mechanisms, enables the aggregation point to map GFEs to their physical origins accurately. This structured approach can enable faster fault isolation, prioritization of maintenance tasks, and potential integration with augmented reality and/or digital twin systems for enhanced operational awareness.

The detecting can be associated with a severity score. Embodiments include computing a severity score 144 for the ground fault event. A severity score may be calculated based on the number of downstream devices impacted, the magnitude of leakage current, the magnitude of voltage or current spikes, the persistence of a PQE over time, the criticality of affected equipment, the potential safety risks, the likelihood of physical damage or operational disruption, and so on. A severity score can be calculated by the IIEMs when a PQE is detected. The severity score can be sent to the aggregation point. The severity score, which can be an additional severity score, can be calculated by the aggregation point which can account for one or more severity scores associated with PQEs that were sent. The aggregation point can compute a severity score with or without separate severity scores from the IIEMs. The severity score enables maintenance teams to rapidly assess the urgency of a fault. For instance, a high-severity ground fault event (GFE) affecting essential process equipment and/or safety systems could trigger immediate alerts and override lower-priority tasks, while a lower-severity fault in a non-critical area might be queued for routine inspection. The severity score can also be used to automatically escalate alerts, initiate shutdown protocols, and/or generate prioritized work orders in maintenance management systems. Over time, aggregating severity data across events can support trend analysis, predictive maintenance, and/or investment planning, helping facility managers identify systemic vulnerabilities and justify equipment upgrades or redesigns. Additionally, historical severity scoring can contribute to compliance documentation and/or insurance reporting, ensuring a well-documented and quantifiable response to power quality and grounding issues.

The flow 100 can include alerting a user 150. Embodiments include alerting a user of the location of the ground fault. Disclosed implementations can include multiple alert types and/or levels. Implementing a multi-tiered alert system for ground fault events (GFEs) can provide critical benefits by ensuring timely response, minimizing equipment damage, and enhancing safety across an industrial facility. When a PQE is detected by an IIEM and a ground fault is confirmed by the aggregation point, disclosed implementations can trigger one or more types of alerts based on the severity, context, location, and so on of the fault. For instance, real-time text message and email notifications can inform key personnel immediately, while instant messaging (IM) integrations with platforms like Slack® or Microsoft Teams® can provide alerts directly to maintenance or engineering channels. For high-severity issues, such as those impacting critical infrastructure or multiple downstream nodes, automated voice calls and/or integration with on-premises alarm systems (e.g., sirens or flashing lights) may be appropriate to ensure rapid awareness. Simultaneously, centralized dashboards and web-based monitoring portals can be updated with detailed fault metadata, including timestamp, location, affected equipment, and calculated severity. One or more environments can be monitored by a centralized system such as mentioned above, regardless of location. These dashboards may include interactive visualizations, like heatmaps or floor plan overlays, to assist with prioritization and fault tracing. High-level implementation can involve defining alert rules and severity thresholds within the aggregation point, managing recipient contact lists and escalation protocols, and using secure communication channels (e.g., HTTPS, secure APIs, and/or SMS gateways) to distribute alerts. Disclosed implementations may further include alert acknowledgment tracking, event replay, and/or automated work order generation in connected maintenance management systems (CMMS), creating a fully integrated and responsive fault handling workflow.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

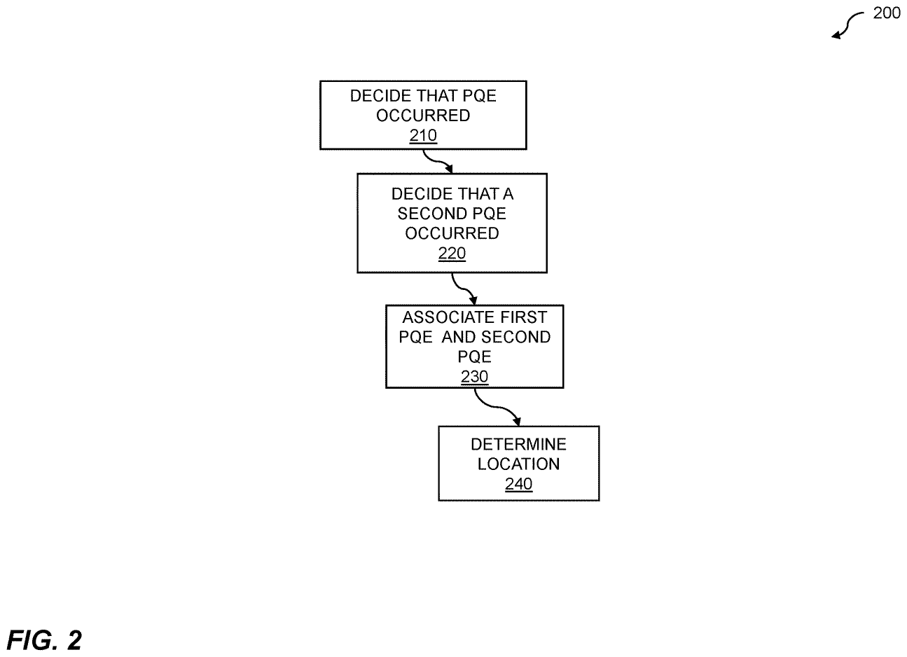

FIG. 2 is a flow diagram for detecting a second event. The flow 200 includes deciding that a PQE occurred 210. Recall that a first IIEM can decide that a first PQE occurred on a first node. As previously stated, a power quality event (PQE) can be identified when measured electrical parameters exceed established thresholds or deviate from anticipated temporal or phase-related behavior. By analyzing these and other parameters, disclosed implementations can infer changes in equipment operational states and correlate those changes with irregularities, such as unexpected voltage or current fluctuations that may signify the onset of a fault condition. Many types of PQEs can be identified and captured by the IIEM including a voltage and/or current phase above an on-voltage threshold or an off-threshold, a rise in a voltage phase above a voltage rise threshold, a rise in a current phase above a current rise threshold, a difference in phase between voltage and current over a threshold, a change in phase between voltage and current above a change threshold rate, and so on.

The flow 200 includes deciding that a second PQE occurred 220. In embodiments, the deciding includes a second IIEM coupled to one or more other nodes within the plurality of nodes, wherein the deciding includes a second PQE, and wherein the second PQE is associated with a second node with the one or more other nodes. The identification/detection of the second PQE can be performed in a manner similar to as previously described for determining a first PQE. The first and second PQEs can be detected by the same IIEM (e.g., on different nodes monitored by an IIEM), or by a different IIEM. Any number of IIEMs can detect a PQE on any number of monitored nodes.

The flow 200 includes associating a first PQE and second PQE 230. Embodiments include associating the first PQE and the second PQE with a single event, wherein the first PQE and the second PQE are synchronous, wherein the first PQE and the second PQE occur within two seconds of each other. Disclosed implementations can be configured to detect and associate multiple power quality events (PQEs) based on temporal and/or spatial correlations, enabling more advanced diagnostics and root cause analysis. For example, a first PQE and a second PQE may be deemed temporally synchronous if they occur within a predefined time window, such as two seconds. Any other time window can be used. If such temporal proximity is detected, disclosed implementations can infer that both PQEs may be symptoms of a single underlying disturbance, such as a failure or abrupt load change in an upstream transformer or distribution panel. This temporal association allows disclosed implementations to suppress redundant alerts, prioritize upstream fault diagnosis, refine severity scoring by evaluating the breadth of the impacted area, and/or localize one or more ground faults.

In addition to temporal correlation, PQEs can be associated based on spatial proximity. Each PQE can include location metadata (e.g., node identifier, building/floor/sector coordinates), allowing disclosed implementations to identify clusters of events that occur in physically adjacent zones. If multiple PQEs occur in close physical proximity, even if they are not exactly synchronous, disclosed implementations may infer that a localized disturbance, such as a partial grounding or shared conductor degradation, may be affecting that region. Combined temporal and spatial analysis can enable disclosed implementations to perform intelligent event grouping, which can be used to generate higher-level summaries for maintenance teams, prioritize investigation zones, and reduce the likelihood of overlooking subtle but related anomalies spread across multiple sensors.

The flow 200 further includes determining a location 240. Recall that IIEMs can send PQEs to an aggregation point. For example, a first IIEM can send a first PQE pertaining to a first node to an aggregation point. Similarly, a second IIEM can send a second PQE pertaining to a second node to the aggregation point. Any number of IIEMs can send PQEs to an aggregation point. Additional aggregation points can be coordinated within the environment. If the aggregation point determines that the PQEs are synchronous (as defined above), the location of a single ground fault event (GFE) can be detected, based on the PQEs sent by the IIEMS. In embodiments, the location is based on a highest current phase rise between the first node and the second node. Recall that the PQEs can be based on a current phase rise above a threshold. In the example above, a current phase rise in a PQE associated with a first node can be larger than a current phase rise in a synchronous PQE associated with a second node. The aggregation point can conclude that the location of the ground fault is on the first node and can alert a user, direct a tool to be shut down, call for an inspection, and/or perform other safety actions. In embodiments, the location is based on a highest voltage phase rise between the first node and the second node. Again, referring to the example above, a voltage phase rise in a PQE associated with the first node can be smaller than a voltage phase rise in a synchronous PQE associated with the second node. The aggregation point can determine that the source of the ground fault is the second node. When asynchronous events are detected by the aggregation point, multiple ground faults can be detected.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

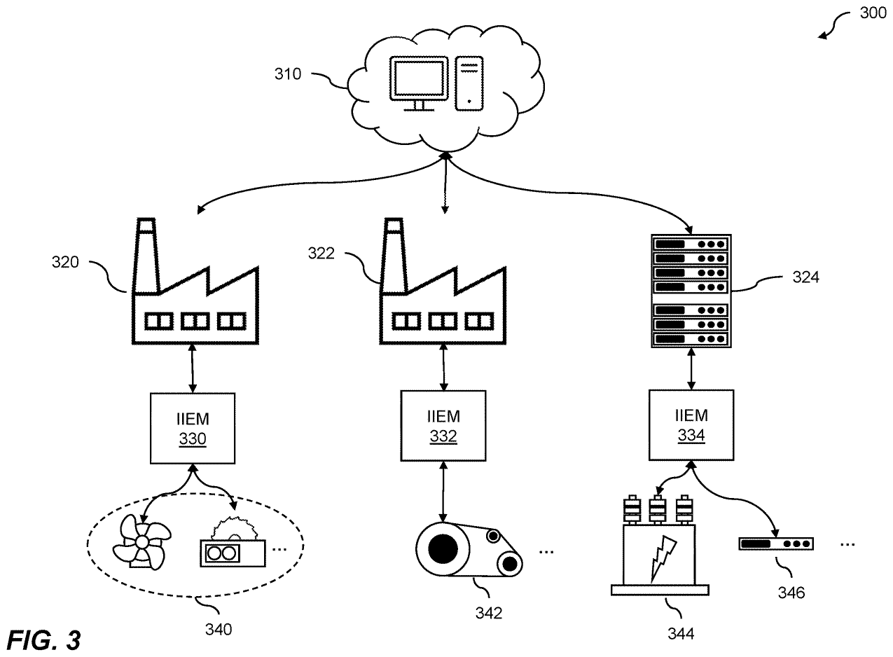

FIG. 3 is an infographic for IoT environments. An IoT environment can enable techniques for equipment monitoring. An industrial IoT electrical monitor (IIEM) can be accessed. The IIEM can be coupled to one or more industrial devices within one or more environments. The IIEM can detect and record any operating condition of electrical equipment such as voltage, current, humidity, temperature, vibration, and so on. The IIEM can receive one or more uploading instructions from a cloud server, aggregation point, etc. The one or more uploading instructions can detail how and when the IIEM should upload electrical data to a cloud server. The IIEM can use different instructions for each coupled piece of electrical equipment. Electrical data associated with one or more industrial devices is recorded by the IIEM. The IIEM can determine whether the electrical data that was recorded represents an anomalous event, a power quality event (PQE), and so on, related to the one or more industrial devices. The determining can be based on the one or more uploading instructions. The IIEM can upload the electrical data to a cloud server, based on the determining. The IIEM can analyze, summarize, etc. the electrical data prior to the uploading. The cloud server, aggregation point, etc. can perform additional calculations to locate failures, such as a ground fault.

The Internet of Things (IoT) can refer to a network of interconnected devices that can exchange information over a network such as the Internet, a mobile network such as 5G or long-term evolution (LTE), a private network, short-range communications networks such as Bluetooth, and so on. The devices can include any function for which communication is desired. For example, IoT devices can be used in securing a home with devices such as security cameras, smart thermostats, smart door locks, kitchen appliances, smoke detectors, and so on. These devices can communicate with other devices, systems, networks, etc. to report a status, an error, an alert, and so on. Software such as a web application or mobile application can accumulate data from IoT devices and show status, connectivity, battery power, live information, warnings, etc. associated with the devices. Many other applications of IoT devices are possible, such as fitness trackers, smart cars, smart lighting, smart appliances such as ovens and refrigerators, smart plugs and outlets, and so on. The Industrial IoT (IIoT) is an extension of IoT for industrial devices to monitor function, environment, behavior, etc. of machines within industrial environments such as data centers, manufacturing facilities, power plants, wastewater treatment facilities, and many others. The devices can comprise sensors, instruments, machines, etc. that can exchange real-time data about the conditions of one or more machines within the environment, report problems, take actions (such as shutting off a machine), and so on. Such devices can include temperature sensors, pressure sensors, vibration sensors, flow sensors, actuators, monitors, programmable logic controllers (PLCs), and many more.

In disclosed implementations, the IIEM can include a Raspberry Pi® equipped with an AI accelerator to enable a machine learning model to process data in real time directly on the IIEM device, without the need for constant communication with a cloud server. This approach can reduce latency, enable faster response times for anomaly detection, and decrease the dependency on network connectivity. Moreover, by processing the data locally, sensitive information remains within the local network, addressing potential security and privacy concerns. This approach allows disclosed implementations to continuously monitor equipment, detect irregularities, and generate alerts or insights, making it an ideal solution for industries where uptime and predictive maintenance are critical.

In disclosed implementations, the IIEM can comprise an IoT node which can interconnect devices, sensors, and servers to collect and exchange information over the Internet. The IIEM can include one or more communication transceivers. The communication transceivers can be based on BLE (Bluetooth Low Energy); Wi-Fi; cellular communication protocols such as 4G, 5G, and LTE-M; and/or other suitable communication protocols. The transceivers can enable high-speed data transfer to cloud servers and/or local networks. Other communication transceivers can include LoRa (Long Range) and/or Zigbee communication receivers. In some cases, one or more IoT nodes may include an Ethernet port, serial port, and/or other port that supports wired communication, instead of, or in addition to, the communication transceivers.

In some implementations, the IIEM can be distinct from an IoT node. The aggregation point can comprise the IoT node. In embodiments, the aggregation point comprises an edge compute device. In embodiments, the aggregation point comprises a cloud server. One or more IIEMs within an environment can be coupled to one or more industrial devices. The one or more IIEMs can send data to the IoT device, such as the aggregation point, which can coordinate sending and receiving data with a compute device such as a computer, server, cloud server, edge server, etc. The IoT device can include one or more processors, communications interfaces, and so on. The IIEM can communicate with the IoT node via Bluetooth®, cellular communications, and so on. In some cases, one or more IoT nodes may include an Ethernet port, serial port, and/or other port that supports wired communication.

The IIEM can include a power source. The power source can include a battery, such as a rechargeable battery. In disclosed implementations, the battery can include a lithium-ion battery, lithium-ion polymer battery, and/or other suitable type of battery. In some cases, one or more IIEMs may include PoE (power over Ethernet) to enable providing both power and network connectivity via a single cable. Some IIEMs may include energy harvesting features, such as solar cells, vibration-based energy generation, and/or other renewable energy sources that can enable remote, self-sustaining IoT monitoring.

The IIEM can include one or more processors. The processors can include an ARM®-based processor, a MIPS®-based processor, a custom processor, application specific integrated circuits (ASICS), systems-on-chip (SoCs), one or more embedded controllers, and/or another suitable processor type. The processors can serve to read sensor data, process interrupts, perform communication tasks, and/or execute other processes to accomplish IoT-based industrial device monitoring. The processor(s) can interface with an input/output (I/O) module. The I/O module can include analog inputs to enable reading signals from analog sensors such as temperature probes, current meters, voltage meters, and so on. The I/O module can include one or more analog-to-digital converters (ADCs) to convert analog signal levels into digital values. The I/O module can include digital inputs and outputs, such as GPIO (General Purpose I/O), in order to interface with other types of sensors such as tilt sensors, gyroscopes, accelerometers, and/or other types of sensors that provide digital outputs. Additionally, the I/O module can interface with an output device, such as an LED, buzzer, or other suitable output device. The I/O module can interface to a wide variety of sensors. The sensors can include temperature and humidity sensors to monitor environmental conditions. The sensors can include vibration sensors, which can be used to detect mechanical wear and/or anomalies in industrial equipment. The sensors can include current sensors and voltage sensors, which can measure power consumption and/or detect electrical issues. Other types of sensors can be used in disclosed implementations.

The IIEM can include computer storage, such as flash memory, for storing firmware images, configuration settings, sensor logs, waveforms, and so on. Additionally, some IIEMs can include an external storage interface, such as a microSD card slot, to enable local retrieval of collected data and/or logs. The computer storage can also include random-access memory (RAM) for supporting program execution and in some cases, analysis and/or processing of collected data.

The IIEM can be coupled to the one or more industrial devices via a network connection. The network connection can be a wireless connection, such as via BLE, Wi-Fi, or some other suitable connection. The network connection can be a wired connection, such as an Ethernet connection, serial connection (e.g., RS-232, RS-485, or the like), and/or other type of wired connection. The coupling can include access, by the IIEM, to internal nodes of the industrial equipment to monitor internal conditions. The coupling can include access to current and/or voltage entering or exiting the industrial device. The one or more industrial devices can include robotic arms, CNC machines, 3D printers, welding machines, injection molding machines, conveyor belts, packaging equipment, sorting machines, uninterruptible power supplies, generators, power transformers, industrial circuit breakers, power distribution units, industrial HVAC systems, furnaces, boilers, refrigeration units, dehumidifiers and humidifiers, pumps, compressors, mixing tanks, wastewater treatment systems, data center computer servers, network switches, routers, and/or other types of industrial devices. Any type of equipment that requires electricity can be monitored by the IIEM.

A single IIEM can be coupled to a single device or multiple devices, providing efficient IoT monitoring. The equipment can be physically located in an environment. Any environment can be monitored by the IIEM. For example, the equipment can be located in a room within a food processing facility, a rack within a data center, a floor within a manufacturing facility, and so on. Any number of IIEMs can be coupled to any number of industrial devices in any number of environments. In a usage example, a single IIEM can be coupled to a bandsaw and a table saw within a wood shop.

The infographic 300 includes a cloud server 310. In disclosed implementations, the cloud server 310 can be implemented as a bare metal server, one or more containerized instances, and/or one or more virtual machines. The cloud server can include a server in a cloud service such as Amazon Web Services (AWS®), a custom-managed server, a local server (e.g., on-site server, computer, and so on), etc. The cloud server can include any number of physical servers within a rack, data center, network, and so on. The cloud server can include any type of processor, ASIC, SoC, AI accelerator, etc. Load balancing and/or orchestration can be used to enable scaling of cloud server capabilities as the number of industrial devices being monitored increases. The cloud server can communicate with one or more IIEM devices located in various environments, such as facilities and/or locations which house equipment. The cloud server can communicate with the one or more IIEM devices via the Internet, cellular networks, satellite networks, and/or other suitable communication techniques. The IIEM can comprise an IoT node.

As shown in infographic 300, a first IIEM 330 is installed within a first environment 320, a second IIEM 332 is installed within a second environment 322, and a third IIEM 334 is installed within a third environment 324. The first and second environments are shown as manufacturing facilities, and the third environment is shown as a data center. In practice, any environment can be monitored by the IIEM. For example, the equipment can be located in a room within a food processing facility, a rack within a data center, a floor within a manufacturing facility, outdoors, and so on. Any number of IIEMs can be coupled to any number of industrial devices in any number of environments. In a usage example, a single IIEM can be coupled to a bandsaw and a table saw within a wood shop. In the infographic 300, IIEM 330 monitors two industrial devices 340, a fan and a table saw, within environment 320. IIEM 332 monitors a single belt drive 342 within environment 322. IIEM 334 monitors a generator 344 and computing equipment 346 within environment 324, a data center.

Environment 320, environment 322, and environment 324 can be located in different geographical regions, or similar regions. The industrial devices can include elevators, centrifuges, saws, drills, conveyor belts, CNC machines, 3D printers, welding machines, injection molding machines, robotic arms, packaging equipment, sorting machines, uninterruptible power supplies, generators, power transformers, industrial circuit breakers, power distribution units, industrial HVAC systems, furnaces, boilers, refrigeration units, dehumidifiers and humidifiers, pumps, compressors, mixing tanks, wastewater treatment systems, data center computer servers, network switches, load balancers, uninterruptible power supplies, routers, and/or other types of industrial devices. The IIEMs shown in infographic 300 can capture data from the industrial equipment, and can analyze, summarize, and/or send the data to the cloud server. The IIEMs can be instrumental in recognizing and preventing industrial equipment failures. The IIEMs can send data to an aggregation point (not shown in infographic 300). The aggregation point can consolidate, summarize, analyze, etc. data sent by any number of IIEMs within the environment. The aggregation point can send and receive data from the cloud server. As described earlier, the aggregation point can localize ground faults that occur within the industrial environment based on power quality events (PQEs) sent by coupled IIEMs.

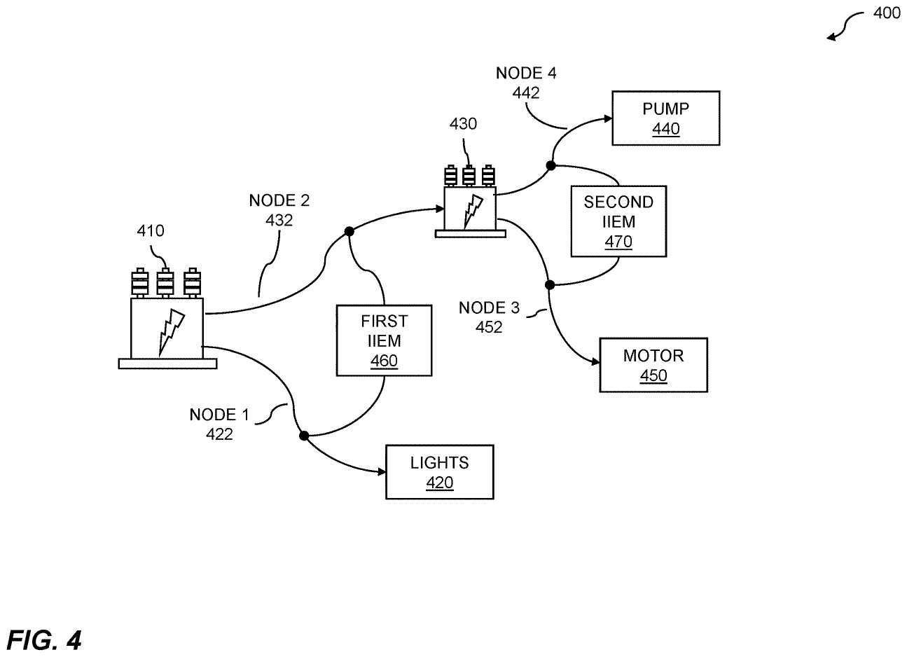

FIG. 4 is an example of monitoring an electrical distribution system. The electrical distribution system can be within a building, a campus of proximal buildings, a manufacturing facility, or other industrial location. In disclosed implementations, the monitoring architecture may be implemented using IIEMs, programmable monitoring nodes, sensors, and/or aggregation logic to analyze electrical characteristics in real-time. The example 400 includes a first transformer 410. The first transformer supplies power for lights 420, and a second transformer 430. A first node 422 denotes input power to the lights. A second node 432 denotes input power to the second transformer 430. The second transformer supplies power to a pump 440 and a motor 450. A third node 452 denotes input power to motor. A fourth node 442 denotes input power to pump. In disclosed implementations, one or more nodes may be instrumented with current and voltage sensors, enabling the capture of waveform data, phase angles, rise and fall times, and other electrical parameters. While the example 400 shows two transformers and four nodes, in practice, there can be many more nodes, transformers, and industrial devices in an electrical distribution system that is monitored by disclosed implementations. A first IIEM 460 monitors node 1 and node 2. A second IIEM 470 monitors node 3 and node 4. Any number of IIEMs can be included in the environment. The IIEMs can be coupled to an aggregation point (not shown). Disclosed implementations can scale with industrial complexity, supporting both centralized and distributed monitoring topologies.

As a monitoring example, if a voltage phase on node 1 exceeds a voltage phase rise threshold, the first IIEM can record a PQE. The PQE can include electrical data, such as voltage, current, etc. The PQE can include the node, a location, a timestamp, one or more industrial devices drawing power from the node, and so on. Embodiments include sending, by the first IIEM, the first PQE to the aggregation point. The aggregation point can collect data from other IIEMs, such as the second IIEM coupled to nodes 3 and 4. Within a certain timeframe, the second IIEM can record a second PQE based on a voltage phase on node 3 exceeding a voltage phase rise threshold. The second IIEM can send the second PQE to the aggregation point. In other embodiments, the deciding includes a second IIEM coupled to one or more other nodes within the plurality of nodes, wherein the deciding includes a second PQE, wherein the second PQE is associated with a second node with the one or more other nodes. The aggregation point can determine if these PQEs are synchronous or asynchronous events. This can be based on a time between the events. Some embodiments include associating the first PQE and the second PQE with a single event, wherein the first PQE and the second PQE are synchronous, wherein the first PQE and the second PQE occur within two seconds of each other. If the events are asynchronous, multiple error conditions can be reported by the aggregation point. If the PQEs are synchronous, the aggregation point can determine the location of the common error, such as a ground fault, by comparing the magnitude of the PQEs. In embodiments, the location is based on a highest current phase rise between the first node and the second node. In other embodiments, the location is based on a highest voltage phase rise between the first node and the second node. In this way, disclosed implementations can narrow down the areas to inspect and/or repair when PQEs are detected, reducing downtime, and improving overall output and efficiency of industrial facilities. Thus, disclosed implementations can provide a proactive monitoring framework that supports predictive maintenance strategies and enhances the resilience of industrial facilities.

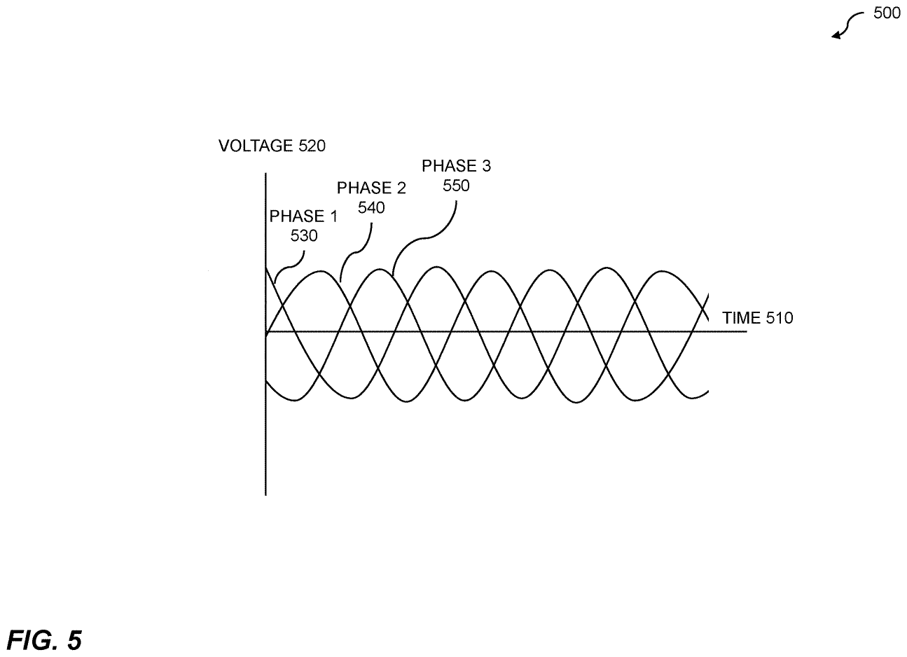

FIG. 5 is an example of three-phase power. The example 500 includes a horizontal axis 510 representing time, and a vertical axis 520 representing voltage magnitude. A first phase 530, second phase 540, and third phase 550 are shown. Three-phase power is a type of AC (alternating current) electrical power distribution that includes three sinusoidal voltage waveforms that are evenly spaced in phase, each offset by 120 degrees. Three-phase power is the most common technique used for transmitting and distributing electrical power in industrial, commercial, and high-power applications, because it provides a more balanced and efficient power delivery compared to single-phase systems. In a balanced three-phase system, each voltage waveform has the same frequency and amplitude (e.g., peak voltage), which minimizes voltage fluctuations and reduces the need for oversized conductors or transformers. The phase relationships allow for constant power transfer, unlike single-phase systems that experience pulsating power delivery. The frequency can typically range from 50 Hertz to 60 Hertz, depending on geographic region. In disclosed implementations, the three-phase power can be in a wye (Y) configuration, which includes a neutral conductor, or a delta (Δ) configuration, which does not require a neutral and can be used in motor loads or balanced systems.

Three-phase power can offer significant advantages in both reliability and performance. One of its key benefits is the ability to power large industrial motors more efficiently, as the rotating magnetic field generated by three-phase current provides smoother and more consistent torque compared to single-phase power. This reduces mechanical vibration and prolongs the life of connected equipment. Additionally, three-phase systems can carry more power over the same conductor size, improving infrastructure efficiency. Common applications include powering HVAC systems, pumps, compressors, conveyors, industrial robotics, and data center infrastructure. The symmetrical nature of three-phase power also allows for simpler electrical balancing and fault detection, making it an ideal foundation for disclosed monitoring systems that analyze waveform anomalies to detect PQEs and GFEs in real time. Disclosed implementations can monitor all three phases for voltage and current anomalies which could indicate problems with industrial equipment, such as ground faults.

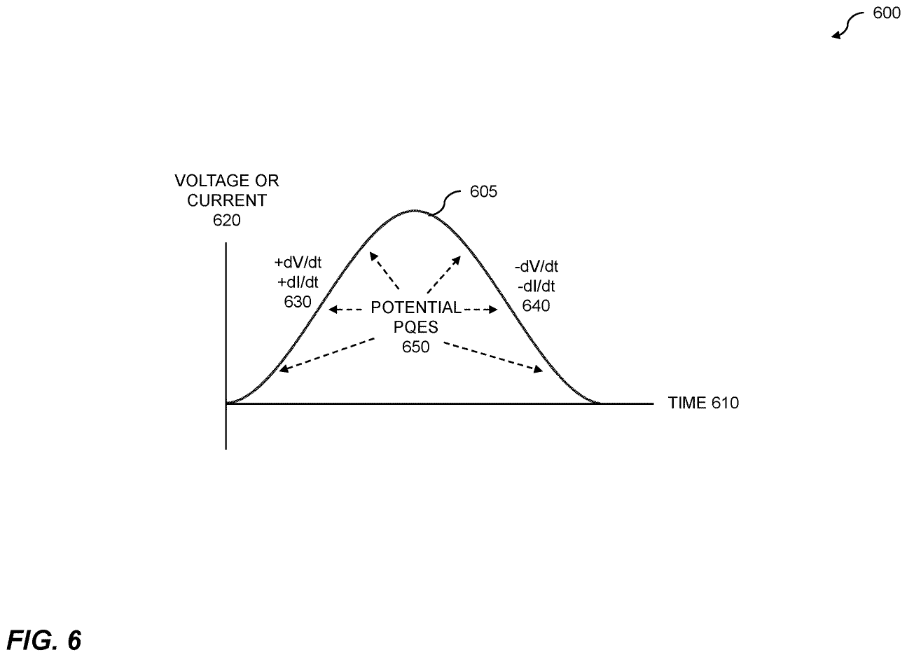

FIG. 6 is an example of a rapid rise or fall in current or voltage at a rate above a threshold. The example 600 includes a horizontal axis 610 representing time, and a vertical axis 620 representing signal magnitude. The signal 605 can represent a voltage signal, phase, etc., or a current signal, phase, etc. The signal 605 can include a positive rise 630. The positive rise can be represented as a positive change in voltage over time (dV/dt), and/or a positive change in current over time (dI/dt). The signal 605 can include a negative rise 640. The negative rise can be represented as a negative change in voltage over time (−dV/dt), and/or a negative change in current over time (−dI/dt). One or more potential PQEs 650 may be detected/identified based on temporal characteristics of signal 605. The temporal characteristics can include rise times, fall times, maximum peak levels, minimum peak levels, duration of time above or below a threshold level, rate-of-change thresholds, transient overshoot or undershoot, waveform distortion (e.g., flattening or oscillation), presence of high-frequency noise or ringing, and zero-crossing irregularities. These characteristics can be compared against learned or expected baseline patterns to identify deviations that may correspond to abnormal electrical behavior or ground faults.

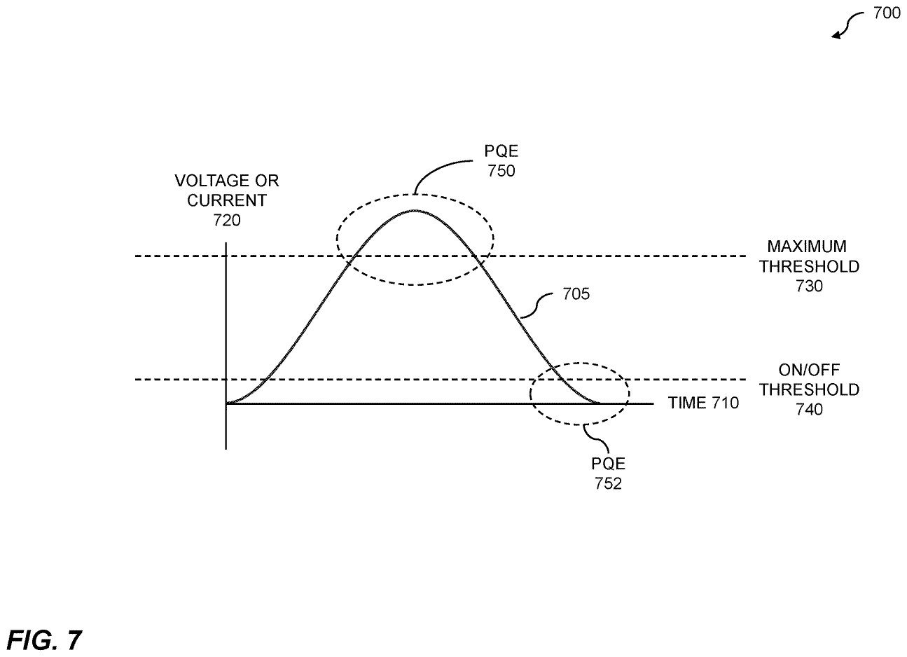

FIG. 7 is an example of a rise in current or voltage above a threshold. The example 700 includes a horizontal axis 710 representing time, and a vertical axis 720 representing signal magnitude. The signal 705 can represent a voltage signal, phase, etc. or a current signal, phase, etc. A maximum threshold 730 can be established. Additionally, an on/off threshold 740 can be established. The on/off threshold can be representative of an expected voltage and/or current level when an industrial device (e.g., motor, pump, etc.) is idle, powered off, or not in use. A first PQE 750 is shown where a level of signal 705 exceeds maximum threshold 730. A second PQE 752 is shown where a level of signal 705 exceeds an on/off threshold 740 while the industrial device is determined to be in an off, idle, or standby state. In disclosed implementations, the determination of an off/idle/standby state for an industrial device can be accomplished by correlating time-of-day operating schedules, monitoring auxiliary control signals (e.g., contactor or relay positions), referencing device-specific usage patterns stored in historical logs, or interpreting real-time control system inputs that indicate operational mode. By establishing customizable thresholds, disclosed implementations can detect/identify PQEs that can be tailored to specific types of equipment and/or operating conditions. For example, a mixer that mixes low viscosity materials may have different thresholds set than a mixer that is designated for mixing high viscosity materials, due to differences in startup current profiles, load behavior, and mechanical resistance. These customizable thresholds can enhance the sensitivity and specificity of PQE detection while minimizing false positives across diverse device categories.

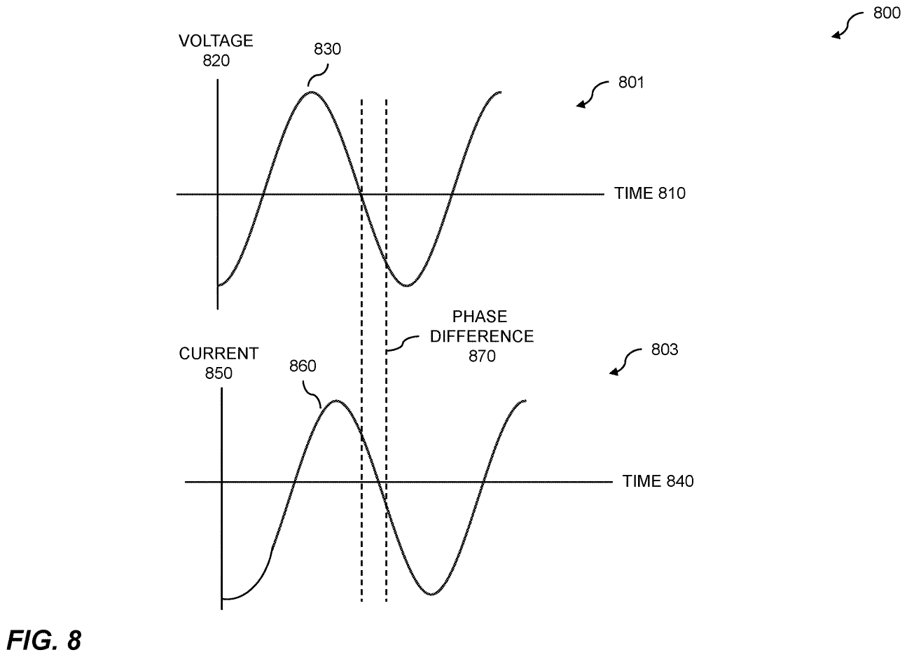

FIG. 8 is an example of a phase difference between voltage and current. The example 800 shows a voltage graph 801 that is vertically aligned with a corresponding current graph 803. The voltage graph 801 includes a horizontal axis 810 representing time, and a vertical axis 820 representing voltage level. Similarly, the current graph 803 includes a horizontal axis 840 representing time, and a vertical axis 850 representing current level. Curve 830 represents a voltage level for a phase of power within a 3-phase power delivery system. Curve 860 represents a current level for the same phase. A phase difference 870 between the voltage curve 830 and the current curve 860 can be indicative of potential electrical problems, including unexpected capacitance and/or inductance in the signal path. The unexpected capacitance or inductance can be represented as a PQE that may be indicative of a ground fault. In some cases, the unexpected capacitance or inductance can be due to insulator damage, dielectric material degradation, contamination from moisture or conductive debris, overheating of windings, and/or aging and fatigue of electrical connectors. In disclosed implementations, the magnitude, rate of change, or volatility of the phase difference 870 can be defined as a PQE, enabling detection of subtle, progressive faults before they escalate into more severe failures. The identification of these PQEs allows for proactive maintenance and targeted diagnostics in industrial environments where equipment uptime and reliability are critical.

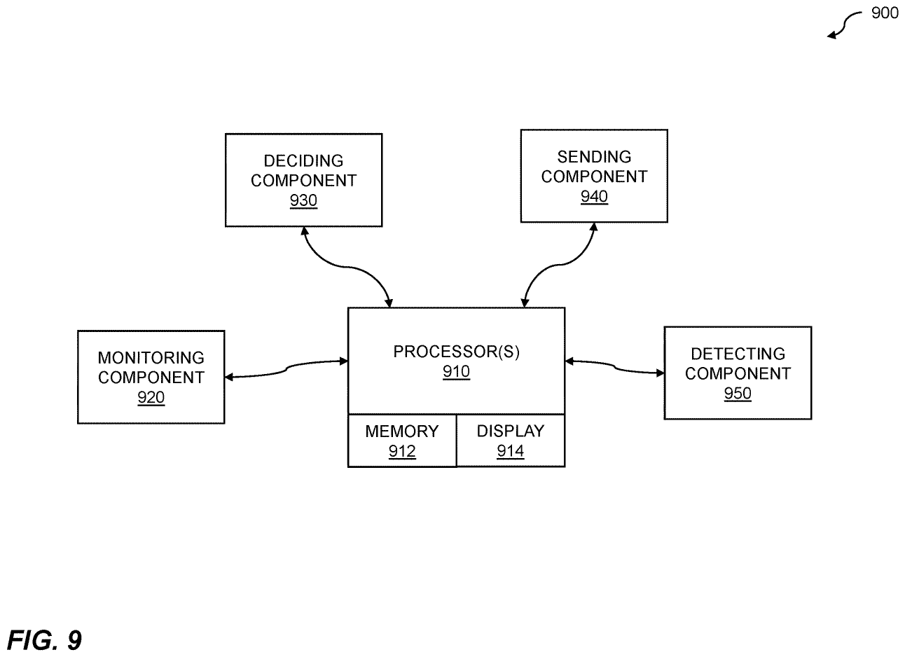

FIG. 9 is a system diagram for ground fault identification with IoT-enabled monitors. The system 900 can comprise a computer system for implementation of ground fault detection and location determination. The computer system can be based on semiconductor logic. The system can include one or more of processors, memories, cache memories, queues, displays, communication channels and networks, and so on. The system 900 can include one or more processors 910. The processors can include standalone processors within integrated circuits or chips, processor cores in FPGAs or ASICs, two or more processor cores within a multiprocessor, and the like. The one or more processors 910 are coupled to a memory 912, which can store instructions, operations, electrical data, data requests, electrical data analysis, heuristics for industrial environments, routing information, and so on. The memory can include one or more of local memory, shared cache memory, shared hierarchical cache memory, system memory such as shared system memory, etc. The system 900 can further include a display 914 coupled to the one or more processors. The display can be used for displaying data, instructions, operations, information regarding ground fault identification with IoT-enabled monitors, and so on.

The system 900 can include a computer program product embodied in a non-transitory computer readable medium for analysis, the computer program product comprising code which causes one or more processors to perform operations of: monitoring, by one or more industrial IoT electrical monitors (IIEMs), a plurality of nodes within an electrical distribution system, wherein the plurality of nodes is coupled to a common transformer, wherein a first IIEM within the one or more IIEMs is coupled to one or more nodes within the plurality of nodes, wherein at least one industrial device is coupled to the one or more nodes, and wherein the one or more IIEMs are coupled to an aggregation point; deciding, by the first IIEM, that a first power quality event (PQE) occurred, wherein the first PQE is associated with a first node within the one or more nodes, and wherein the deciding is based on the monitoring; sending, by the first IIEM, the first PQE to the aggregation point; and detecting a ground fault event, by the aggregation point, wherein the detecting is based on the first PQE that was sent, and wherein the detecting includes a location of a ground fault.

The system 900 can include a computer system for analysis comprising: a memory which stores instructions; one or more processors attached to the memory, wherein the one or more processors, when executing the instructions which are stored, are configured to: monitor, by one or more industrial IoT electrical monitors (IIEMs), a plurality of nodes within an electrical distribution system, wherein the plurality of nodes is coupled to a common transformer, wherein a first IIEM within the one or more IIEMs is coupled to one or more nodes within the plurality of nodes, wherein at least one industrial device is coupled to the one or more nodes, and wherein the one or more IIEMs are coupled to an aggregation point; decide, by the first IIEM, that a first power quality event (PQE) occurred, wherein the first PQE is associated with a first node within the one or more nodes, and wherein the deciding is based on the monitoring; send, by the first IIEM, the first PQE to the aggregation point; and detect a ground fault event, by the aggregation point, wherein the detecting is based on the first PQE that was sent, and wherein the detecting includes a location of a ground fault.

The system 900 includes a monitoring component 920. The monitoring component 920 can include functions and instructions for monitoring, by one or more industrial IoT electrical monitors (IIEMs), a plurality of nodes within an electrical distribution system, wherein the plurality of nodes is coupled to a common transformer, wherein a first IIEM within the one or more IIEMs is coupled to one or more nodes within the plurality of nodes, wherein at least one industrial device is coupled to the one or more nodes, and wherein the one or more IIEMs are coupled to an aggregation point. Each IIEM can be configured to read data from one or more nodes within an electrical distribution system, and/or perform direct measurements via dedicated channels, enabling flexible integration into a wide range of industrial environments. The measurements can include voltage, current, phase, resistance, temperature of conductors, and/or other relevant electrical and environmental parameters. In some implementations, the IIEM may also capture frequency, harmonic distortion, power factor, and rise/fall time characteristics to support detailed analysis of power quality events (PQEs). This multi-modal sensing capability can enable both high-resolution monitoring of equipment behavior and contextual awareness of surrounding conditions, enhancing the accuracy of anomaly detection and fault localization.

The system 900 includes a deciding component 930. The deciding component 930 can include functions and instructions for deciding, by the first IIEM, that a first power quality event (PQE) occurred, wherein the first PQE is associated with a first node within the one or more nodes, and wherein the deciding is based on the monitoring. The determination of PQEs can include detecting traversal of one or more thresholds, such as voltage level thresholds, current level thresholds, phase drift thresholds, rise time thresholds, and/or other relevant parameters. These thresholds can be static, adaptive, or learned over time based on historical data and operating conditions, allowing the system to distinguish between normal transient behavior and true ground fault events.

The system 900 includes a sending component 940. The sending component 940 can include functions and instructions for sending, by the first IIEM, the first PQE to the aggregation point. Data can be monitored and/or recorded by an IIEM. In embodiments, the monitoring is based on a sampling frequency. The data that is monitored and/or recorded can be sent to an aggregation point. In embodiments, the sampling frequency is 20 kHz. In embodiments, the sending is based on a schedule. The schedule can be daily, hourly, weekly, or some other user-defined schedule. The sending component can also support event-driven transmissions, where a PQE that exceeds a predefined severity threshold triggers immediate transmission regardless of the regular schedule. In some implementations, the sending mechanism includes buffering and prioritization logic, ensuring that critical alerts are delivered with low latency, while less urgent data is sent during off-peak communication windows. Transmission protocols can include MQTT, HTTP, or other lightweight IoT messaging standards suitable for reliable delivery in bandwidth-constrained environments.

The system 900 includes a detecting component 950. The detecting component 950 can include functions and instructions for detecting a ground fault event, by the aggregation point, wherein the detecting is based on the first PQE that was sent, and wherein the detecting includes a location of a ground fault. The location can be based on a predefined node topology that can be based on CAD data, or other data that describes the electrical connections between transformers and industrial devices within an industrial facility. The node topology can also incorporate hierarchical identifiers such as building number, floor level, zone, and device ID, enabling precise fault localization. In some implementations, the detecting component cross-references PQEs from multiple IIEMs to triangulate the fault location based on correlated timing and signal characteristics. Additionally, historical data trends and machine learning models can assist in refining the location estimate, particularly in complex or noisy environments. This enables maintenance teams to quickly dispatch personnel to the most likely point of failure, minimizing downtime.

In some implementations, machine learning techniques may be employed to further enhance the accuracy and responsiveness of ground fault detection. For example, supervised learning models can be trained on historical PQE data to identify subtle patterns or combinations of electrical characteristics that precede or accompany ground faults, improving predictive capabilities. Additionally, anomaly detection algorithms can flag previously unseen or complex fault conditions that may not be easily captured by static thresholds. However, since ground fault detection is a specialized type of electrical fault with well-defined signal signatures, such as sudden voltage drops, current leakage, or phase shifts, disclosed implementations may alternatively rely solely on rule-based heuristics. This heuristic approach provides a lightweight, low-cost, and easily implementable solution that is well suited for deployment in resource-constrained environments or in industrial facilities that prioritize simplicity, transparency, and reliability over complexity.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript®, ActionScript®, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for analysis comprising:
monitoring, by one or more industrial IoT electrical monitors (IIEMs), a plurality of nodes within an electrical distribution system, wherein the plurality of nodes is coupled to a common transformer, wherein a first IIEM within the one or more IIEMs is coupled to one or more nodes within the plurality of nodes, wherein at least one industrial device is coupled to the one or more nodes, and wherein the one or more IIEMs are coupled to an aggregation point;
deciding, by the first IIEM, that a first power quality event (PQE) occurred, wherein the first PQE is associated with a first node within the one or more nodes, and wherein the deciding is based on the monitoring;
sending, by the first IIEM, the first PQE to the aggregation point; and
detecting a ground fault event, by the aggregation point, wherein the detecting is based on the first PQE that was sent, and wherein the detecting includes a location of a ground fault.

2. The method of claim 1 wherein the first PQE includes a voltage phase, within the first node, above an on-voltage threshold.

3. The method of claim 1 wherein the first PQE includes a voltage phase, within the first node, above an off-voltage threshold, wherein the at least one industrial device coupled to the first node is not in operation.

4. The method of claim 1 wherein the first PQE includes a current phase above an on-current threshold.

5. The method of claim 1 wherein the first PQE includes a current phase, within the first node, above an off-current threshold, wherein the at least one industrial device coupled to the first node is not in operation.

6. The method of claim 1 wherein the first PQE includes a rise, within the first node, in a voltage phase above a voltage rise threshold, wherein the voltage rise threshold is twice a normal operating voltage rise rate.

7. The method of claim 1 wherein the first PQE includes a rise, within the first node, in a current phase above a current rise threshold, wherein the current rise threshold is twice a normal operating current rise rate.

8. The method of claim 1 wherein the first PQE includes a phase difference, within the first node, between a voltage phase of power and a current phase of power, wherein the phase difference is above a phase threshold.

9. The method of claim 8 further comprising monitoring, by the first IIEM, the phase difference.

10. The method of claim 9 wherein the first PQE includes a rate of change of the phase difference above a phase difference threshold rate.

11. The method of claim 1 wherein the deciding includes a second IIEM coupled to one or more other nodes within the plurality of nodes, and wherein the deciding includes a second PQE, wherein the second PQE is associated with a second node with the one or more other nodes.

12. The method of claim 11 further comprising associating the first PQE and the second PQE with a single event, wherein the first PQE and the second PQE are synchronous, wherein the first PQE and the second PQE occur within two seconds of each other.

13. The method of claim 12 wherein the location is based on a highest current phase rise between the first node and the second node.

14. The method of claim 12 wherein the location is based on a highest voltage phase rise between the first node and the second node.

15. The method of claim 1 wherein the monitoring is based on a sampling frequency.

16. The method of claim 15 wherein the sampling frequency is 20 kHz.

17. The method of claim 1 wherein the sending is based on a schedule.

18. The method of claim 1 further comprising alerting a user of the location of the ground fault.

19. The method of claim 1 wherein the first IIEM includes two input paths, wherein the two input paths comprise different voltage dividers, and wherein the first IIEM includes a programmable real-time unit (PRU).

20. The method of claim 19 further comprising selecting, by the PRU, an input path within the two input paths, wherein the selecting is based on a magnitude of an input.

21. The method of claim 1 further comprising computing a severity score for the ground fault event.

22. A computer program product embodied in a non-transitory computer readable medium for analysis, the computer program product comprising code which causes one or more processors to perform operations of:
monitoring, by one or more industrial IoT electrical monitors (IIEMs), a plurality of nodes within an electrical distribution system, wherein the plurality of nodes is coupled to a common transformer, wherein a first IIEM within the one or more IIEMs is coupled to one or more nodes within the plurality of nodes, wherein at least one industrial device is coupled to the one or more nodes, and wherein the one or more IIEMs are coupled to an aggregation point;
deciding, by the first IIEM, that a first power quality event (PQE) occurred, wherein the first PQE is associated with a first node within the one or more nodes, and wherein the deciding is based on the monitoring;
sending, by the first IIEM, the first PQE to the aggregation point; and
detecting a ground fault event, by the aggregation point, wherein the detecting is based on the first PQE that was sent, and wherein the detecting includes a location of a ground fault.

23. A computer system for analysis comprising:
a memory which stores instructions;
one or more processors attached to the memory, wherein the one or more processors, when executing the instructions which are stored, are configured to:
monitor, by one or more industrial IoT electrical monitors (IIEMs), a plurality of nodes within an electrical distribution system, wherein the plurality of nodes is coupled to a common transformer, wherein a first IIEM within the one or more IIEMs is coupled to one or more nodes within the plurality of nodes, wherein at least one industrial device is coupled to the one or more nodes, and wherein the one or more IIEMs are coupled to an aggregation point;
decide, by the first IIEM, that a first power quality event (PQE) occurred, wherein the first PQE is associated with a first node within the one or more nodes, and wherein the deciding is based on the monitoring;
send, by the first IIEM, the first PQE to the aggregation point; and
detect a ground fault event, by the aggregation point, wherein the detecting is based on the first PQE that was sent, and wherein the detecting includes a location of a ground fault.
